(19) United States
(12) Patent Application Publication
(10) Pub. No.: US 2005/0168597 A1
(43) Pub. Date: Aug. 4, 2005

(54) Methods and apparatuses for formatting and displaying content

(76) Inventors: Clay Fisher, San Diego, CA (US); Eric Edwards, San Jose, CA (US); Neal Manowitz, Montebello, NY (US); Robert Sato, San Diego, CA (US); Brian Beaver, San Francisco, CA (US)

Correspondence Address: Valley Oak Law, 5655 Silver Creek Valley Road, #106, San Jose, CA, 95138, US

(21) Appl. No.: 10/772,208

(22) Filed: Feb. 4, 2004

(51) Int. Cl. H04N 5/76

(52) U.S. Cl. 348/231.3; 348/211.3

(57) ABSTRACT

In one embodiment, the methods and apparatuses for formatting and displaying content capture an image with a device; detect an image parameters related to the image; store the image parameters such that the image parameters are available for access at a later time; and display the image in a display location based on at least one of the image parameters.

### FIELD OF THE INVENTION

The present invention relates generally to formatting and displaying content and, more particularly, to synchronizing and identifying content based on location of the content.

### BACKGROUND

There has been a proliferation of content utilized by users. This content typically includes video tracks, graphic images, and photographs. In many instances, the content utilized by a user is stored without fully realizing the relationship between each piece of content.

For example, images are typically captured with attention paid to the visual quality of the image. Unfortunately, additional unique information about each image that describes the environment of the image is not captured.

Managing this increasing amount of content is a challenge for many users. With the increasing amount of content, it is also more difficult to track additional unique information related to the environment of each image.

### SUMMARY

In one embodiment, the methods and apparatuses for formatting and displaying content capture an image with a device; detect an image parameters related to the image; store the image parameters such that the image parameters are available for access at a later time; and display the image in a display location based on at least one of the image parameters.

### BRIEF DESCRIPTION OF THE DRAWINGS

The accompanying drawings, which are incorporated in and constitute a part of this specification, illustrate and explain one embodiment of the methods and apparatuses for synchronizing and identifying content. In the drawings,

FIG. 1 is a diagram illustrating an environment within which the methods and apparatuses for formatting and displaying content are implemented;

FIG. 2 is a simplified block diagram illustrating one embodiment in which the methods and apparatuses for formatting and displaying content are implemented;

FIG. 3 is a simplified block diagram illustrating a system, consistent with one embodiment of the methods and apparatuses for formatting and displaying content;

FIG. 4 is an exemplary record for use with the methods and apparatuses for formatting and displaying content;

FIG. 5A is a data structure consistent with one embodiment of the methods and apparatuses for formatting and displaying content;

FIG. 5B is a data structure consistent with another embodiment of the methods and apparatuses for formatting and displaying content;

FIG. 6 is a flow diagram consistent with one embodiment of the methods and apparatuses for formatting and displaying content;

FIG. 7 is a flow diagram consistent with one embodiment of the methods and apparatuses for formatting and displaying content;

FIG. 8 is a flow diagram consistent with one embodiment of the methods and apparatuses for formatting and displaying content; and

FIG. 9 is an exemplary diagram illustrating one embodiment of the methods and apparatuses for formatting and displaying content.

### DETAILED DESCRIPTION

The following detailed description of the methods and apparatuses for formatting and displaying content refers to the accompanying drawings. The detailed description is not intended to limit the methods and apparatuses for formatting and displaying content. Instead, the scope of the methods and apparatuses for formatting and displaying content is defined by the appended claims and equivalents. Those skilled in the art will recognize that many other implementations are possible, consistent with the present invention.

References to “content” includes data such as images, video, graphics, and the like, that are embodied in digital or analog electronic form.

References to “electronic device” includes a device such as a video camera, a still picture camera, a cellular phone with an image capture module, a personal digital assistant with an image capture module, and an image capturing device.

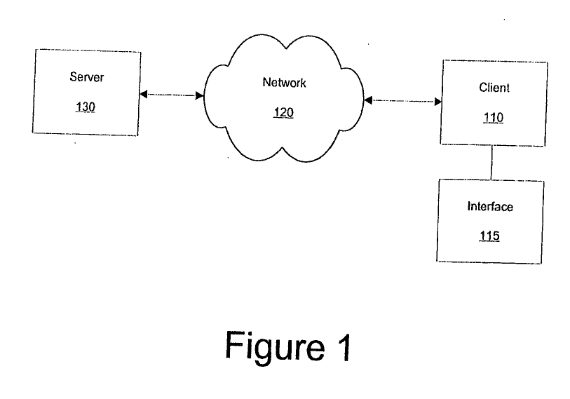

FIG. 1 is a diagram illustrating an environment within which the methods and apparatuses for formatting and displaying content are implemented. The environment includes an electronic device 110 (e.g., a computing platform configured to act as a client device, such as a computer, a personal digital assistant, a digital camera, a video camera), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces in the same housing as personal digital assistant electronics (e.g., as in a Clie® manufactured by Sony Corporation). In other embodiments, one or more user interface 115 components (e.g., a keyboard, a pointing device (mouse, trackball, etc.), a microphone, a speaker, a display, a camera are physically separate from, and are conventionally coupled to, electronic device 110. The user utilizes interface 115 to access and control content and applications stored in electronic device 110, server 130, or a remote storage device (not shown) coupled via network 120.

In accordance with the invention, embodiments of formatting and displaying content below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

The methods and apparatuses for formatting and displaying content are shown in the context of exemplary embodiments of applications in which images are displayed in a particular format and location based on parameters associated with the image. In one embodiment, the image is utilized through the electronic device 110 and the network 120. In another embodiment, the image is formatted and displayed by the application which is located within the server 130 and/or the electronic device 110.

In one embodiment, the methods and apparatuses for formatting and displaying content automatically creates a record associated with an image. In one instance, information within the record is automatically completed by the methods and apparatuses for formatting and displaying content based on previously stored records associated with corresponding images.

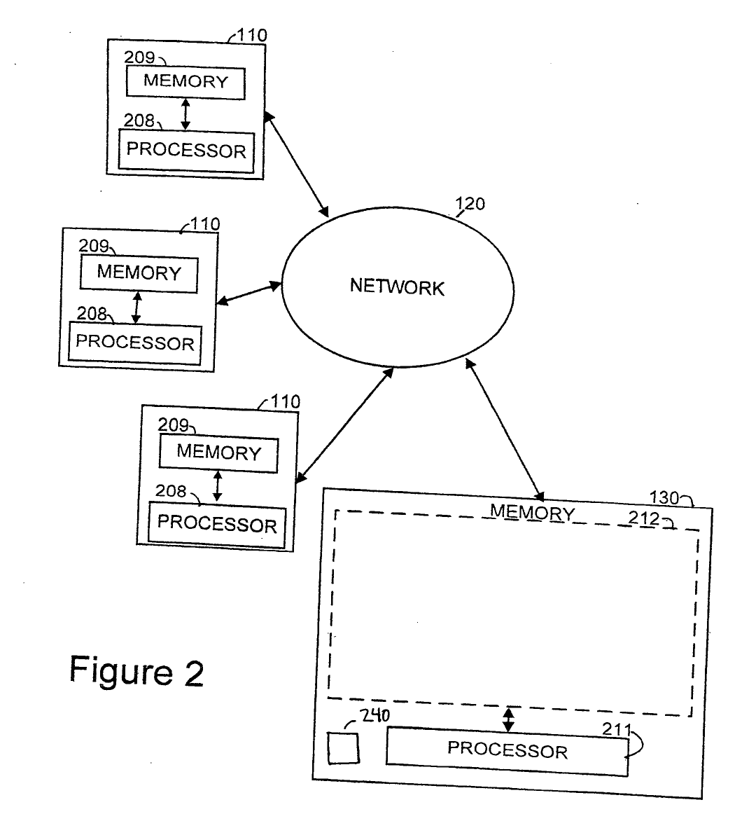

FIG. 2 is a simplified diagram illustrating an exemplary architecture in which the methods and apparatuses for formatting and displaying content are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. A unique user operates each electronic device 110 via an interface 115 as described with reference to FIG. 1.

Server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

The plurality of client devices 110 and the server 130 include instructions for a customized application formatting and displaying content. In one embodiment, the plurality of computer-readable medium 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in memories 209, in memory 211, or a single user application is stored in part in one memory 209 and in part in memory 211. In one instance, a stored user application, regardless of storage location, is made customizable based on formatting and displaying content as determined using embodiments described below.

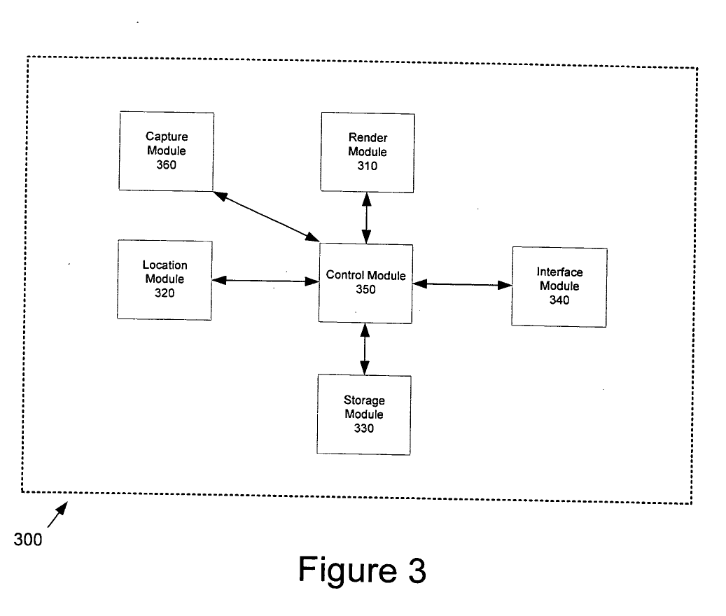

FIG. 3 illustrates one embodiment of a formatting and displaying system 300. In one embodiment, the system 300 is embodied within the server 130. In another embodiment, the system 300 is embodied within the electronic device 110. In yet another embodiment, the system 300 is embodied within both the electronic device 110 and the server 130.

In one embodiment, the system 300 includes a render module 310, a location module 320, a storage module 330, an interface module 340, a control module 350, and a capture module.

In one embodiment, the control module 350 communicates with the render module 310, the location module 320, the storage module 330, the interface module 340, and the capture module 360. In one embodiment, the control module 350 coordinates tasks, requests, and communications between the render module 310, the location module 320, the storage module 330, the interface module 340, and the capture module 360.

In one embodiment, the render module 310 displays an image based on image data and location data. In another embodiment, the render module 310 displays multiple images based on image data and location data of each image. In one embodiment, the image data is identified by the capture module 360. In one instance, the image data is in the form of a JPEG file. In another instance, the image data is in the form of a RAW file. In yet another instance, the image data is in the form of a TIFF file.

In one embodiment, the location data is identified by the location module 320. In one instance, the location data illustrates a particular location of the device such as a street address of the device. In another instance, the location data also illustrates a positional orientation of the device such as the horizon, line of sight, and the like. In yet another instance, the location also illustrates an image location as seen through the viewfinder or the device such as the area captured by the viewfinder, the zoom of the lens, and the like.

In one embodiment, the location module 320 processes the location data. In one embodiment, the location data includes general location data that provides the broad location of the device on a street by street granularity. In another embodiment, the location data includes image location data that provides specific location data as seen through the viewfinder of the device.

In one embodiment, the general location data is gathered by a global positioning satellite (GPS) system. In this embodiment, the GPS system senses the location of the device and is capable of locating the device. In another embodiment, the general location data is gathered by multiple cellular phone receivers that is capable of providing a location of the device.

In one embodiment, the image location data is supplied by at least one sensor within the device that provides a direction that the viewfinder is pointed and the amount of information that is shown in the viewfinder. In one instance, the device senses the direction of the viewfinder and displays this direction through a coordinate calibrated with respect to due North. In another instance, the device senses the current focal length of the device and determines the amount of information that is available to the viewfinder.

In one embodiment, the location module 320 supplies the general location data and the image location data related to a specific image to the system 300.

In one embodiment, the storage module 330 stores a record including the location data associated with a specific content. In another embodiment, the storage module 330 also stores the specific content that is associated with the record.

In one embodiment, the interface module 340 receives a request for a specific function from one of the electronic devices 110. For example, in one instance, the electronic device requests content from another device through the system 300. In another embodiment, the interface module 340 receives a request from a user of a device. In yet another embodiment, the interface module 340 displays information contained within the record associated with the content.

In one embodiment, the capture module 360 identifies a specific image for use by the system 300. In one embodiment, the capture module 320 identifies the specific image. In another embodiment, the capture module 320 processes the specific image captured by the device.

The system 300 in FIG. 3 is shown for exemplary purposes and is merely one embodiment of the methods and apparatuses for formatting and displaying content. Additional modules may be added to the system 300 without departing from the scope of the methods and apparatuses for formatting and displaying content. Similarly, modules may be combined or deleted without departing from the scope of the methods and apparatuses for formatting and displaying content.

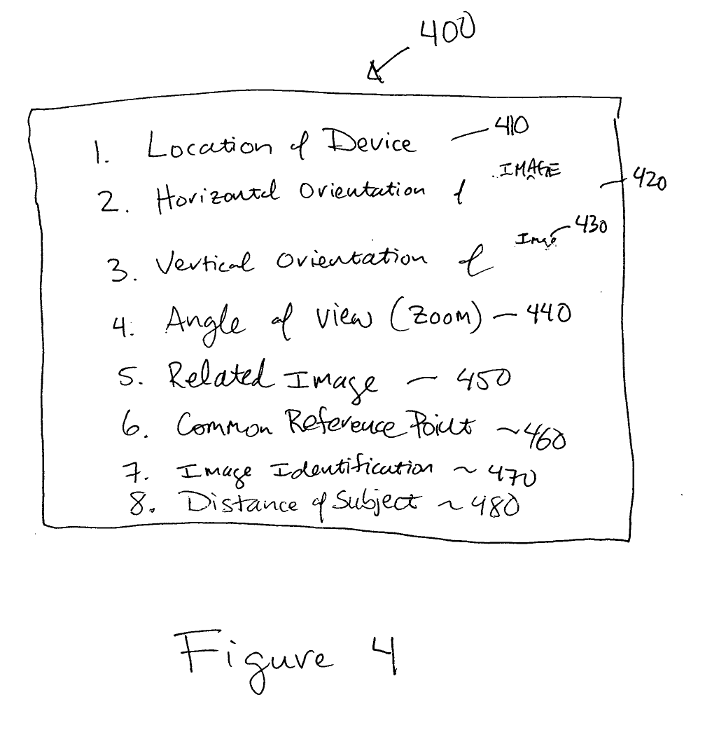

FIG. 4 illustrates an exemplary record 400 for use with the system 300. The record 400 is associated with a specific content. In some embodiments, the record 400 includes a general location of device field 410, a horizontal orientation of image field 420, a vertical orientation of image field 430, an angle of view field 440, a related image field 450, a common reference point field 460, an image identification field 470, and distance of subject field 480.

In one embodiment, the general location of device field 410 indicates a location of the device while capturing the corresponding image. In one embodiment, the location of the device is expressed in geographical coordinates such as minutes and seconds. In another embodiment, the location of the device is expressed as a street address or an attraction.

In one embodiment, the horizontal orientation of image field 420 indicates the horizontal direction of the corresponding image. In one embodiment, the horizontal orientation is expressed in terms of degrees from Due North.

In one embodiment, the vertical orientation of image field 430 indicates the vertical direction of the corresponding image. In one embodiment, the vertical direction is expressed in terms of degrees from the horizon line.

In one embodiment, the angle of view field 440 indicates the overall image area captured within the corresponding image. For example, the angle of view is expressed in terms of a zoom or magnification amount in one embodiment.

In one instance, the general location of device field 410, the horizontal orientation of image field 420, the vertical orientation of image field 430, and the angle of view field 440 are captured by the device while capturing the corresponding image. In combination, the parameters associated with general location of device field 410, the horizontal orientation of image field 420, the vertical orientation of image field 430, and the angle of view field 440 are capable of sufficiently describing the corresponding image in comparison with other images that have similar parameters recorded.

In one embodiment, the related image field 450 indicates at least one other image that is related to the image associated with the record 400. For example, another image having a location of device field 410 that is similar to the location of the device for this specific image is considered a related image. In one embodiment, the related image has a different horizontal orientation or a different vertical orientation from the specific image. In another embodiment, the related image has a different angle of view from the specific image.

In one embodiment, the common reference point 460 identifies a common reference location to multiple images. In one embodiment, the common reference location is calculated from the device. In another embodiment, the common reference location is calculated from each corresponding image.

In one embodiment, the image identification field 470 identifies the image. In one instance, the image description field 470 includes a descriptive title for the specific image. In another instance, the image identification field 470 includes a unique identification that corresponds to the specific image.

In one embodiment, the distance of subject 480 field identifies the distance between the device capturing the image and the subject of the image. In one embodiment, this distance is calculated from the focusing mechanism within the device.

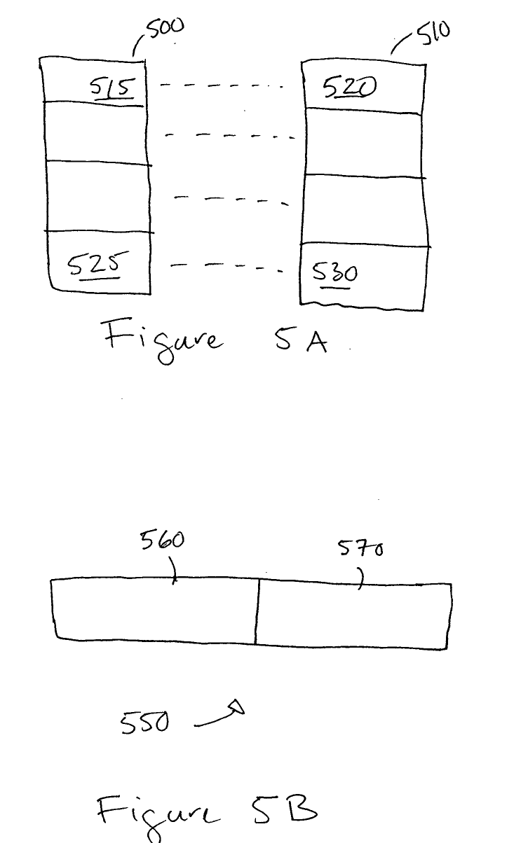

FIG. 5A illustrates a data structure for use with the record 400, a corresponding image, and the system 300. The data structure includes a record table 500 and an image table 510. In one embodiment, the record table 500 is stored within the storage module 330. In another embodiment, the image table 510 is stored within the storage module 330.

In one embodiment, the record table 500 includes a record 515 and a record 525 which are similar to the record 400. In one embodiment, the image table 510 includes an image 520 and an image 530. In one instance, the record 515 corresponds with the image 520; and the record 525 corresponds with the image 530. Although the images and corresponding records are stored separately in this embodiment, the images and corresponding records are configured to be logically linked together such that when one of the images are utilized, the corresponding record is capable of being identified.

FIG. 5B illustrates a data structure 550 for use with the record 400, a corresponding image, and the system 300. In one embodiment, the data structure 550 includes a record 560 coupled with a corresponding image 570. In this embodiment, both the image and corresponding record are coupled together such that when the image is utilized, the record is available without further action.

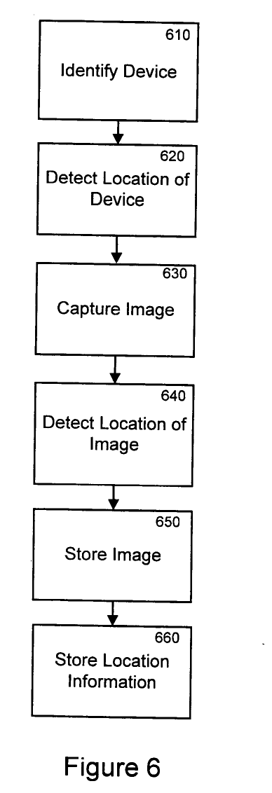

The flow diagrams as depicted in FIGS. 6, 7, and 8 are one embodiment of the methods and apparatuses for formatting and displaying content. The blocks within the flow diagrams can be performed in a different sequence without departing from the spirit of the methods and apparatuses for synchronizing and tracking content. Further, blocks can be deleted, added, or combined without departing from the spirit of the methods and apparatuses for synchronizing and tracking content.

The flow diagram in FIG. 6 illustrates capturing an image and location information corresponding to the image according to one embodiment of the invention. In Block 610, an electronic device that captures images is identified. In one embodiment, the particular electronic device is identified by the user. In one embodiment, the electronic device is a digital camera, a video camera, a personal digital device with an image capture module, a cellular phone with an integrated camera, and the like.

In Block 620, the location of the electronic device is detected. In one embodiment, the location of the device is stored within the general location of device field 410.

In Block 630, an image is captured by the electronic device.

In Block 640, image information that corresponds with the image captured within the Block 630 is detected. In one embodiment, the image information includes the horizontal orientation of the image, the vertical orientation of the image, the angle of view, and/or the distance from the object. In one embodiment, the horizontal orientation of the image, the vertical orientation of the image, and the angle of view are recorded within the horizontal orientation of the image field 420, the vertical orientation of the image field 430, and the angle of view field 440, respectively.

In Block 650, the image is stored. In one embodiment, the image is stored within the storage module 330. In one instance, the image is stored within a table as shown in FIG. 5A. In another instance, the image is independently stored as shown in FIG. 5B.

In Block 660, the device location and image information are stored. In one embodiment, the device location and image information are stored within the storage module 330. In one instance, the device location and image information are stored within a table and linked to a corresponding image as shown in FIG. 5A. In another instance, the device location and image information are stored coupled to the corresponding image as shown in FIG. 5B.

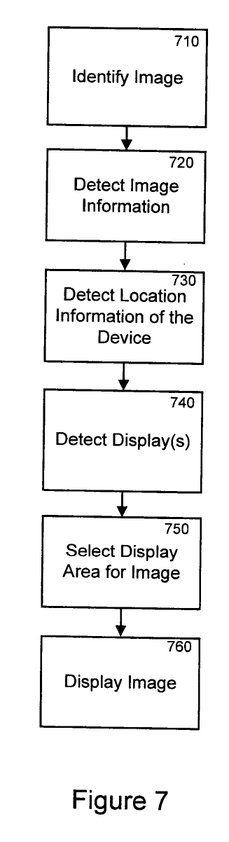

The flow diagram in FIG. 7 illustrates displaying an image according to one embodiment of the invention. In Block 710, a particular image is identified. In one embodiment, the particular image is identified through the image identification field 470.

In Block 720, image information that corresponds with the particular image is detected. In one embodiment, the image information includes the horizontal orientation of the image, the vertical orientation of the image, and/or the angle of view. In one embodiment, the horizontal orientation of the image, the vertical orientation of the image, and the angle of view are recorded within the horizontal orientation of the image field 420, the vertical orientation of the image field 430, and the angle of view field 440, respectively.

In one embodiment, the image information is detected through the record 400 that corresponds with the particular image.

In Block 730, the location information of the device is detected. In one embodiment, the location of the device corresponds to the location when the particular image was captured by the device. In one embodiment, the location information is found within the record 400.

In Block 740, an available display device is detected. In one embodiment, a single display device is detected. In another embodiment, multiple display devices are detected. In one embodiment, the display device is coupled to the render module 310.

In one embodiment, the display device is a display screen configured to visually display the image on the display screen. In another embodiment, the display device is a printer device configured to produce printed material on a tangible media.

In Block 750, an area is selected to display the particular image on the display device. In one embodiment, the area is selected based on the location information of the device. In another embodiment, the area is selected based on the image information.

In Block 760, the image is displayed within the selected area on the display device. In one embodiment, in the case of a single display screen, the image is displayed within the selected area on the single display screen based on the image information and/or the device location. For example, a lower right hand corner of the display screen is utilized to display based on the image information for the identified image.

In another embodiment, in the case of multiple display screens, the image is displayed on a particular display screen based on the image information and/or the device location. For example, with two displays located next to each other, the display located on the left is utilized to display the identified image based on the image information.

In yet another embodiment, in the case of tangible media within a printer device, the image is displayed within the selected area on the tangible media based on the image information and/or the device location. For example, a lower right hand corner of the tangible media is utilized to display based on the image information for the identified image.

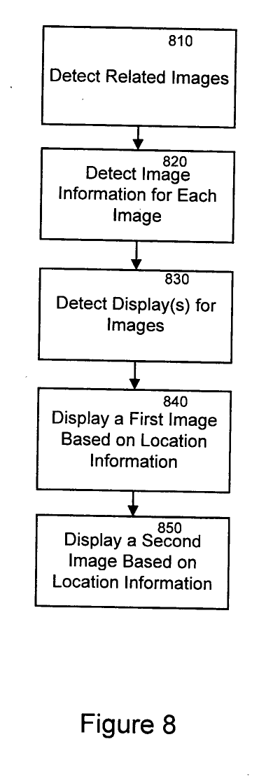

The flow diagram in FIG. 8 illustrates displaying an image according to another embodiment of the invention. In Block 810, related images are identified. In one embodiment, the related images are determined based on the proximity of the location information of the device when capturing each respective image. In one instance, the proximity of the device location is customizable to determine the threshold for identifying related images.

In another embodiment, a user identifies the related images.

In Block 820, image information that corresponds with each of the related images is detected. In one embodiment, the image information includes the horizontal orientation of the image, the vertical orientation of the image, and/or the angle of view. In one embodiment, the horizontal orientation of the image, the vertical orientation of the image, and the angle of view are recorded within the horizontal orientation of the image field 420, the vertical orientation of the image field 430, and the angle of view field 440, respectively.

In one embodiment, the image information is detected through the record 400 that corresponds with the particular image.

In Block 830, an available display device is detected. In one embodiment, a single display device is detected. In another embodiment, multiple display devices are detected. In one embodiment, the display device is coupled to the render module 310.

In one embodiment, the display device is a display screen configured to visually display the image on the display screen. In another embodiment, the display device is a printer device configured to produce printed material on a tangible media.

In Block 840, a first related image is displayed within a first area within the display device. In one embodiment, the image information corresponding to the first related image determines the first area. In another embodiment, the image information of the first related image determines which display device is selected to display the first related image.

In Block 850, a second related image is displayed within a second area within the display device. In one embodiment, the image information corresponding to the second related image determines the second area. In another embodiment, the image information of the first related image determines which display device is selected to display the second related image.

In one embodiment, the first related image and the second related image are displayed relative to each other based on comparing the image information for both the first related image and the second related image. For example, if the first related image is captured with a horizontal orientation to the right of the second related image, then the first related image is displayed to the right of the second related image.

In another embodiment, the first related image and the second related image are displayed relative to each other based on comparing the image information for both the first related image and the second related image relative to a common reference point. For example, if the first related image is captured with a vertical orientation above the common reference point and the second related image is captured with a vertical orientation below the common reference point, then the first related image is displayed above the right of the second related image.

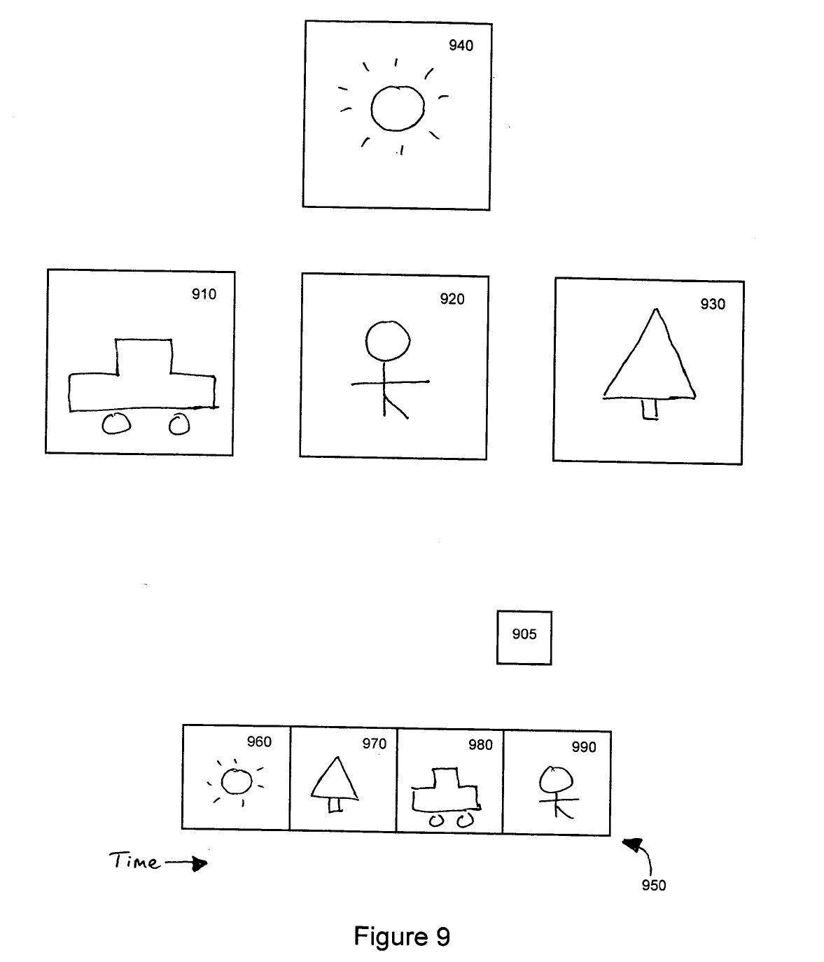

FIG. 9 is an exemplary diagram illustrating the display of related images on multiple display devices. In one embodiment, a stream of captured images 950 are displayed on multiple devices. In this embodiment, the stream of captured images 950 include images 960, 970, 980, and 990. The image 960 was captured prior to the image 970; the image 970 was captured prior to the image 980; and the image 980 was captured prior to the image 990. In one embodiment, each of the images 960, 970, 980, and 990 includes information as shown in the record 400.

In one embodiment, the display devices include display devices 910, 920, 930, and 940 that are depicted in locations relative to a placeholder 905. In another embodiment, the display devices 910, 920, 930, and 940 represent different locations within a single display device.

In one embodiment, the placeholder 905 represents a camera device that recorded the stream of captured image 950. In another embodiment, the placeholder 950 represents a reference point utilized by the stream of captured images 950.

In one embodiment, the image 960 is displayed on the display device 940; the image 970 is displayed on the display 930; the image 980 is displayed on the display 910; and the image 990 is displayed on the display 920. In this embodiment, the stream of captured images 950 could have been captured in any order. In one embodiment, the images 960, 970, 980, and 990 are arranged and displayed according to the system 300 with respect to the placeholder 905. For example, when the images 960, 970, 980, and 990 were captured, the image 940 was located above the image 920; the image 910 was located to the left of the image 920; and the image 930 was located to the right of the image 920. Even though the images 960, 970, 980, and 990 were captured in a different order within the stream of captured images 950, they are positioned in their respective displays based on the position while being captured.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A method comprising:
capturing an image with a device;
detecting an image parameter related to the image;
storing the image parameter such that the image parameter is available for access at a later time; and
displaying the image in a display location based on the image parameter.

2. The method according to claim 1 wherein the device is a camera.

3. The method according to claim 1 further comprising storing the image.

4. The method according to claim 1 further comprising detecting a location of the device when the image is captured.

5. The method according to claim 4 detecting related images based on the location of the device.

6. The method according to claim 5 wherein the detecting related images further comprises comparing a first location of the device corresponding to a first image and a second location of the device corresponding to a second image.

7. The method according to claim 1 wherein the image is a photograph.

8. The method according to claim 1 wherein the image is one frame in a video sequence.

9. The method according to claim 1 wherein the image parameter is a horizontal orientation of the image.

10. The method according to claim 1 wherein the image parameter is a vertical orientation of the image.

11. The method according to claim 1 wherein the image parameter is an angle of view of the image.

12. The method according to claim 1 wherein the image parameter is a location of the image relative to the device.

13. A system comprising:
means for capturing an image with a device;
means for detecting an image parameters related to the image;
means for storing the image parameters such that the image parameters are available for access at a later time; and
means for displaying the image in a display location based on at least one of the image parameters.

14. A method comprising:
detecting a first image and a second image;
detecting a first image parameter and a second image parameter corresponding with the first image and the second image respectively;
displaying the first image in a first display location based on the first image parameter; and
displaying the second image in a second display location based on the second image parameter.

15. The method according to claim 14 further comprising storing the first image parameter and the second image parameter such that the firs image parameter and the second image parameter are available for access at a later time.

16. The method according to claim 14 further comprising capturing the first image.

17. The method according to claim 14 further comprising capturing the first image parameter.

18. The method according to claim 14 wherein the first display location is shown on a first display device and the second display location is shown on a second display device.

19. The method according to claim 14 wherein the first display location and the second display location is shown on a display device.

20. The method according to claim 14 wherein the first display location and the second display are embodied on a tangible medium.

21. The method according to claim 14 wherein the first image parameter is a horizontal orientation of the image.

22. The method according to claim 14 wherein the first image parameter is a vertical orientation of the image.

23. The method according to claim 14 wherein the first image parameter is an angle of view of the image.

24. The method according to claim 14 further comprising selecting the first image and the second image based on a first device location and a second device location corresponding to the first image and the second image, respectively.

25. A system, comprising:
a location module for capturing an image parameter that describes an image;
a storage module configured for storing the image parameter; and
a render module configured for displaying the image in a particular location based on the image parameter.

26. The system according to claim 25 further comprising a capture module configured to record the image.

27. The system according to claim 25 wherein the image includes one of a photograph and a frame within a video sequence.

28. The system according to claim 25 wherein the location module detects a location of a device while the image is captured.

29. The system according to claim 25 wherein the storage module is configured to store a record including the image parameter wherein record corresponds to the image.

30. The system according to claim 25 wherein the storage module is configured to store a synchronization program.

32. A computer-readable medium having computer executable instructions for performing a method comprising:
detecting a first image and a second image;
detecting a first image parameter and a second image parameter corresponding with the first image and the second image respectively;
displaying the first image in a first display location based on the first image parameter; and
displaying the second image in a second display location based on the second image parameter.
